(19) United States
(12) Patent Application Publication
(10) Pub. No.: US 2025/0373987 A1
(43) Pub. Date: Dec. 4, 2025

(54) Speaker

(71) Applicant: AAC Microtech (Changzhou) Co., Ltd., Changzhou City (CN)

(72) Inventor: Chao Zhang, Changzhou (CN)

(21) Appl. No.: 18/984,858

(22) Filed: Dec. 17, 2024

Related U.S. Application Data
(63) Continuation of application No. PCT/CN2024/097115, filed on Jun. 3, 2024.

(51) Int. Cl. H04R 9/06; H04R 1/06; H04R 7/04; H04R 7/18; H04R 9/02; H04R 9/04

(52) U.S. Cl. CPC H04R 9/06; H04R 1/06; H04R 7/04; H04R 7/18; H04R 9/025; H04R 9/045; H04R 2400/11

(57) ABSTRACT

The present invention provides a speaker including a frame, a vibration system, and a magnetic circuit system mounted with the frame. The vibration system includes a diaphragm fixed on the frame and a voice coil driving the diaphragm to generate sounds. The diaphragm includes at least one conductive portion. The voice coil is electrically connected to the conductive portion. The speaker further includes at least one conductive structure fixed to the frame and connecting the conductive portion with an external circuit. The conductive structure includes a main body portion fixedly connected to the frame and a connecting portion bending and extending from the main body portion in a direction close to the diaphragm. The connecting portion is electrically connected to the conductive portion. The present invention provides a speaker with a large magnetic circuit volume and better acoustic performance.

### FIELD OF THE PRESENT INVENTION

The present invention relates to the field of acoustic-electro conversion, and more particularly, to a speaker.

### DESCRIPTION OF RELATED ART

With the development of science and technology, portable electronic products such as mobile phones, handheld game consoles, navigation devices, and handheld multimedia entertainment devices are widely used in people's daily lives. Among these mobile electronic devices, voice playback devices are essential components, and the quality of voice directly affects the user's experience when using these mobile electronic devices. Therefore, the requirements for speakers used in these mobile electronic devices are becoming increasingly high.

In order to achieve the lightweight design of mobile electronic devices, the internal space of speakers is also becoming smaller and smaller. In related art, speaker includes a frame, a vibration system, a magnetic circuit system, and a flexible circuit board. The vibration system includes a diaphragm fixed to the frame and a voice coil that drives the diaphragm to vibrate and generate sounds. However, in related art, the flexible circuit board occupies too much space due to the flexible circuit board is arranged laterally, which causing the space of the magnetic circuit system to be limited, and resulting in insufficient driving force of the magnetic circuit system, and furthermore, affecting the acoustic performance of the speaker.

Therefore, it is desired to provide a new speaker which can overcome the above problems.

### SUMMARY

In view of the above, the embodiments of the present invention provide a speaker with a large volume of the magnetic circuit system while satisfying miniaturization, and the acoustic performance of the speaker is better.

The present invention provides a speaker including a frame, a vibration system mounted with the frame, and a magnetic circuit system mounted with the frame. The vibration system includes a diaphragm fixed on the frame and a voice coil driving the diaphragm to generate sounds. The diaphragm includes a conductive portion. The voice coil is electrically connected to the conductive portion. The speaker further includes a conductive structure fixed to the frame and connecting the conductive portion with an external circuit. The conductive structure includes a main body portion fixedly connected to the frame and a connecting portion bending and extending from the main body portion in a direction close to the diaphragm. The connecting portion is electrically connected to the conductive portion of the diaphragm.

As an improvement, the conductive portion is arranged on one side of the diaphragm or at least partially embedded in the diaphragm.

As an improvement, a number of the conductive portions is two, and two adjacent corner areas of the diaphragm are each provided with one conductive portion, the number of the conductive structures being also two, and each conductive structure arranged corresponding to a position of the conductive portion.

As an improvement, the conductive structure is a conductive metal sheet or a flexible circuit board.

As an improvement, the conductive structure includes a substrate and a conductive material dispersed in the substrate, and the conductive material is at least one of graphene, carbon nanotubes, conductive nanofibers, silver powder, and liquid metal.

As an improvement, the diaphragm includes a dome portion and a suspension portion arranged around the dome portion, the voice coil fixed to the dome portion, the suspension portion including a bending portion, an outer fixing portion bending and extending from an outer periphery of the bending portion, and an inner fixing portion bending from an inner periphery of the bending portion, the outer fixing portion fixedly connected to the frame, and the inner fixing portion fixedly connected to the dome portion.

As an improvement, the conductive portion includes a first conductive portion arranged on the inner fixing portion or the dome portion, and a second conductive portion arranged on the outer fixing portion, the first conductive portion electrically connected to the voice coil, and the second conductive portion electrically connected to the connecting portion.

As an improvement, the first conductive portion is fixedly connected to a leading wire of the voice coil through a conductive adhesive, and the second conductive portion is fixedly connected to the connecting portion through the conductive adhesive, the voice coil, the diaphragm, and the conductive structure achieving circuit conduction with the external circuit.

As an improvement, the frame includes a top surface and a bottom surface arranged opposite to the top surface, an inner side wall and an outer side wall connecting the top surface and the bottom surface, the inner side wall and the outer side wall arranged opposite to each other, the main body portion of the conductive structure fixed to the bottom surface.

As an improvement, the outer fixing portion of the suspension portion locates on the top surface and the outer side wall, and the connecting portion of the conductive structure includes a first portion bending and extending from an outer side of the main body portion along the outer side wall in a direction close to the top surface, and a second portion bending and extending from the first portion in the direction close to the bending portion of the suspension portion, the frame further providing at least one avoidance groove formed by recessing from the top surface to the bottom surface to avoid the second portion, and the second portion accommodated in the avoidance groove.

As an improvement, the outer fixing portion of the suspension portion locates on the top surface, the inner side wall, and the outer side wall of the frame, the connecting portion of the conductive structure including an extension part bending and extending from an inner side of the main body portion along the inner side wall in the direction close to the diaphragm, the extension part electrically connected to the second conductive portion of the diaphragm.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a speaker of the present invention.

FIG. 2 is an exploded view of the speaker of FIG. 1.

FIG. 3 is an illustrative cross-sectional view of the speaker taken along line A-A of FIG. 1 when the connecting portion arranged along the outer side wall.

FIG. 4 is an enlarged partial view of part B in FIG. 3.

FIG. 5 is an illustrative isometric view of the conductive structure when the connecting portion arranged along the outer side wall.

FIG. 6 is an illustrative cross-sectional view of the speaker taken along line A-A of FIG. 1 when the connecting portion arranged along the inner side wall.

FIG. 7 is an enlarged partial view of part C in FIG. 6.

FIG. 8 is an illustrative isometric view of the conductive structure when the connecting portion arranged along the inner side wall.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

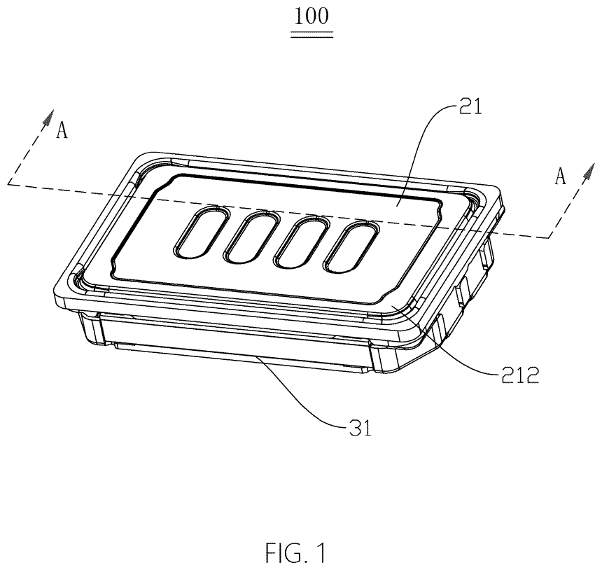

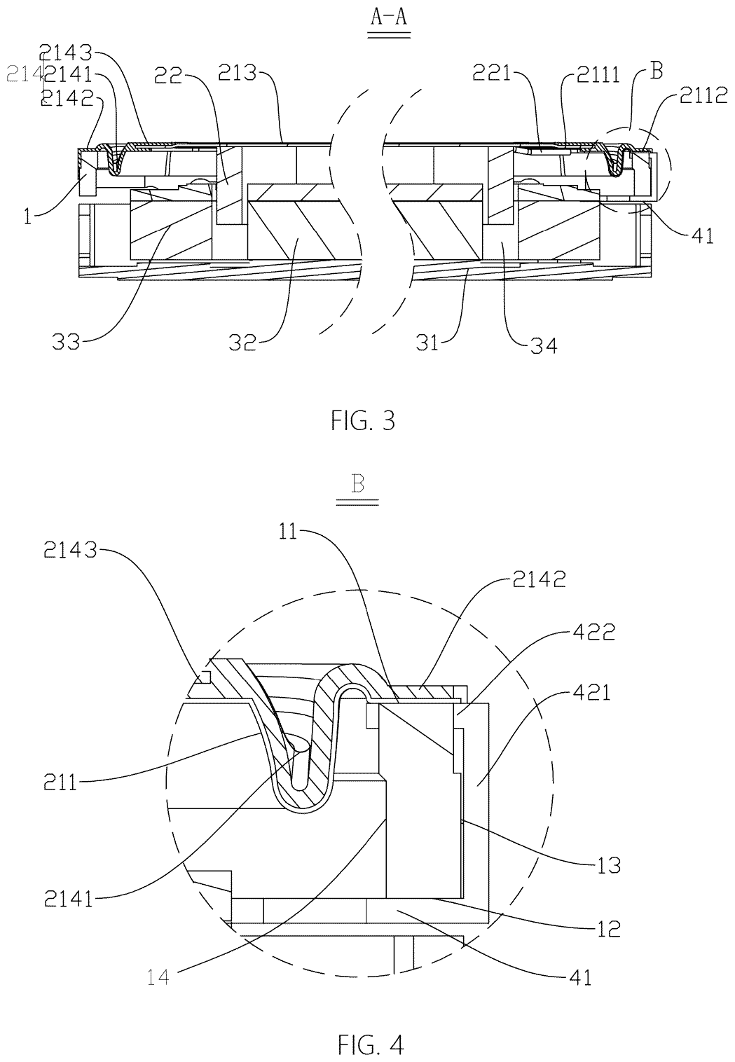

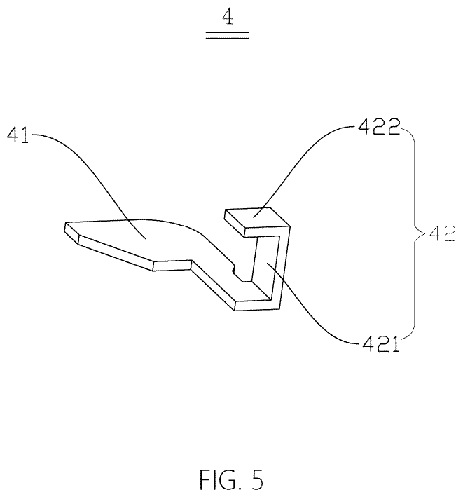

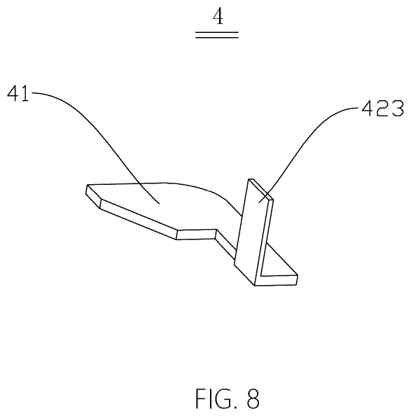

Referring to the FIGS. 1-8, the present invention provides one embodiment of a speaker 100. The speaker 100 includes a frame 1, a vibration system 2 mounted with the frame 1, and a magnetic circuit system 3 mounted with the frame 1.

The vibration system 2 includes a diaphragm 21 fixed on the frame 1 and a voice coil 22 driving the diaphragm 21 to generate sounds. The diaphragm 21 includes at least one conductive portion 211. The voice coil 22 is electrically connected to the conductive portion 211. The speaker 100 further includes at least one conductive structure 4 fixed to the frame 1 and connecting the conductive portion 211 with an external circuit. The conductive structure 4 includes a main body portion 41 fixedly connected to the frame 1 and a connecting portion 42 bending and extending from the main body portion 41 in a direction close to the diaphragm 21. The connecting portion 42 is electrically connected to the conductive portion 211 of the diaphragm 21.

Optionally, the conductive portion 211 is arranged on one side of the diaphragm 21 or at least partially embedded in the diaphragm 21. It should be noted that the conductive portion 211 can be a conductive coating applied on the side of the diaphragm 21 facing to the magnetic circuit system 3, can be a conductive material attached to the diaphragm 21, can be a conductive material at least partially embedded in the diaphragm 21, or can be a conductive material doped or mixed into a substrate of the diaphragm 21, etc., and which is not limited here.

Optionally, in present embodiment, a number of the conductive portions 211 is two, and two adjacent corner areas of the diaphragm 21 are each provided with one conductive portion 211. Alternatively, in other embodiments, the conductive portion 211 can also be provided on a long axis side or a short axis side of the diaphragm 21, and so on. The number of the conductive structures 4 is also two, and each conductive structure 4 is arranged corresponding to a position of the conductive portion 211. By setting it in this way, the connecting portion 42 can be connected to the conductive portion 211 in a shortest path, thereby achieving the goal of reducing the space occupied by the conductive structure 4.

Optionally, the conductive structure 4 is a conductive metal sheet or a flexible circuit board.

Optionally, the conductive structure 4 includes a substrate and a conductive material dispersed in the substrate. And the conductive material is at least one of graphene, carbon nanotubes, conductive nanofibers, silver powder, and liquid metal. Of course, the conductive structure 4 also can be a conductive component made of other materials, and there are no limitations here.

As shown in Figs, the frame 1 includes a top surface 11 and a bottom surface 12 arranged opposite to the top surface 11, an outer side wall 13 and an inner side wall 14 connecting the top surface 11 and the bottom surface 12. The inner side wall 14 and the outer side wall 13 are arranged opposite to each other. The main body portion 41 of the conductive structure 4 is fixed to the bottom surface 12.

Furthermore, the diaphragm 21 includes a dome portion 213 and a suspension portion 214 arranged around the dome portion 213. The voice coil 22 is fixed to the dome portion 213. The suspension portion 214 includes a bending portion 2141, an outer fixing portion 2142 bending and extending from an outer periphery of the bending portion 2141, and an inner fixing portion 2143 bending from an inner periphery of the bending portion 2141. The outer fixing portion 2142 is fixedly connected to the frame 1, and the inner fixing portion 2143 fixedly connected to the dome portion 213.

The conductive portion 211 includes a first conductive portion 2111 arranged on the inner fixing portion 2143 or the dome portion 213, and a second conductive portion 2112 arranged on the outer fixing portion 2142. The first conductive portion 2111 is electrically connected to the voice coil 22, and the second conductive portion 2112 is electrically connected to the connecting portion 42.

Optionally, the first conductive portion 2111 is fixedly connected to a leading wire 221 of the voice coil 22 through a conductive adhesive. By using conductive adhesive to bond the first conductive portion 2111 with the leading wire 221 of the voice coil 22, it improves the stability of the connection between the leading wire 221 and the conductive portion 211. The second conductive portion 2112 is fixedly connected to the connecting portion 42 through the conductive adhesive. The voice coil 22, the diaphragm 21, and the conductive structure 4 achieve circuit conduction with the external circuit.

Optionally, the magnetic circuit system 3 includes a lower plate 31 fixed to the frame 1, a main magnetic assembly 32 fixed to an upper surface of the lower plate 31, and an auxiliary magnetic assembly 33 arranged around the main magnetic assembly 32. The main magnetic assembly 32 is spaced apart from the auxiliary magnetic assembly 33 to form a magnetic gap 34. The lower plate 31 is made of magnetic conductive material.

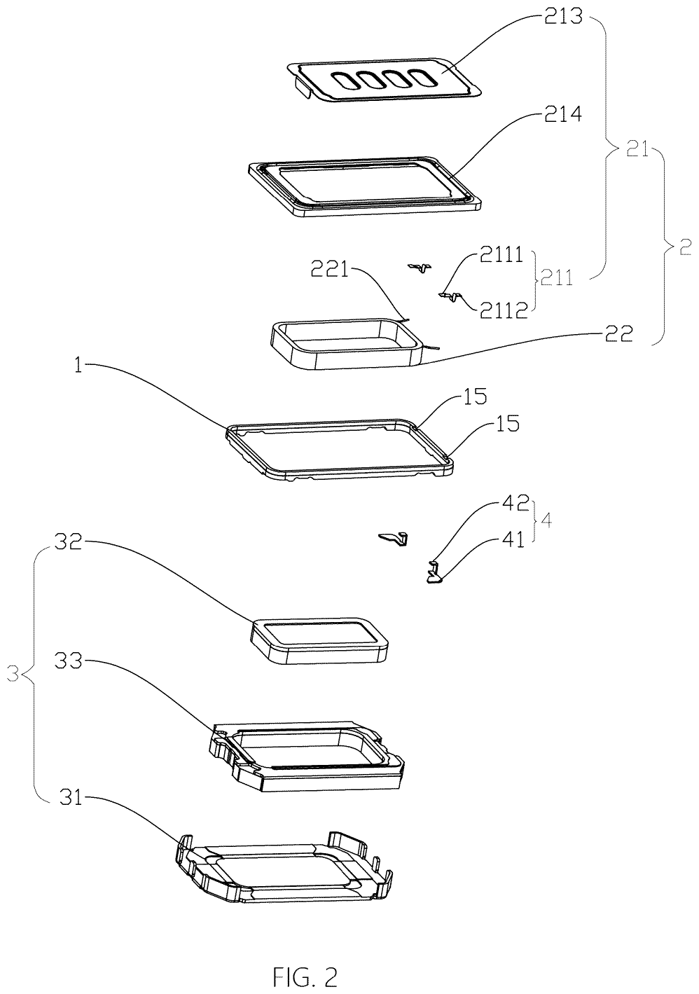

Referring to the FIGS. 2-5, the connecting portion 42 can be arranged extending along the outer side wall 13 of the frame 1. The outer fixing portion 2142 of the suspension portion 214 locates on the top surface 11 and the outer side wall 13. The connecting portion 42 of the conductive structure 4 includes a first portion 421 bending and extending from an outer side of the main body portion 41 along the outer side wall 13 in a direction close to the top surface 11, and a second portion 422 bending and extending from the first portion 421 in the direction close to the bending portion 2141 of the suspension portion 214. The frame 1 further provides at least one avoidance groove 15 formed by recessing from the top surface 11 to the bottom surface 12 to avoid the second portion 422. In present embodiment, the number of the avoidance grooves 15 is two. The second portion 422 is accommodated in the avoidance groove 15 and electrically connected to the second conductive portion 2112. This arrangement can minimize the space occupied by the conductive structure 4 and also make the fixing of the outer fixing portion 2142 to the frame 1 more stable.

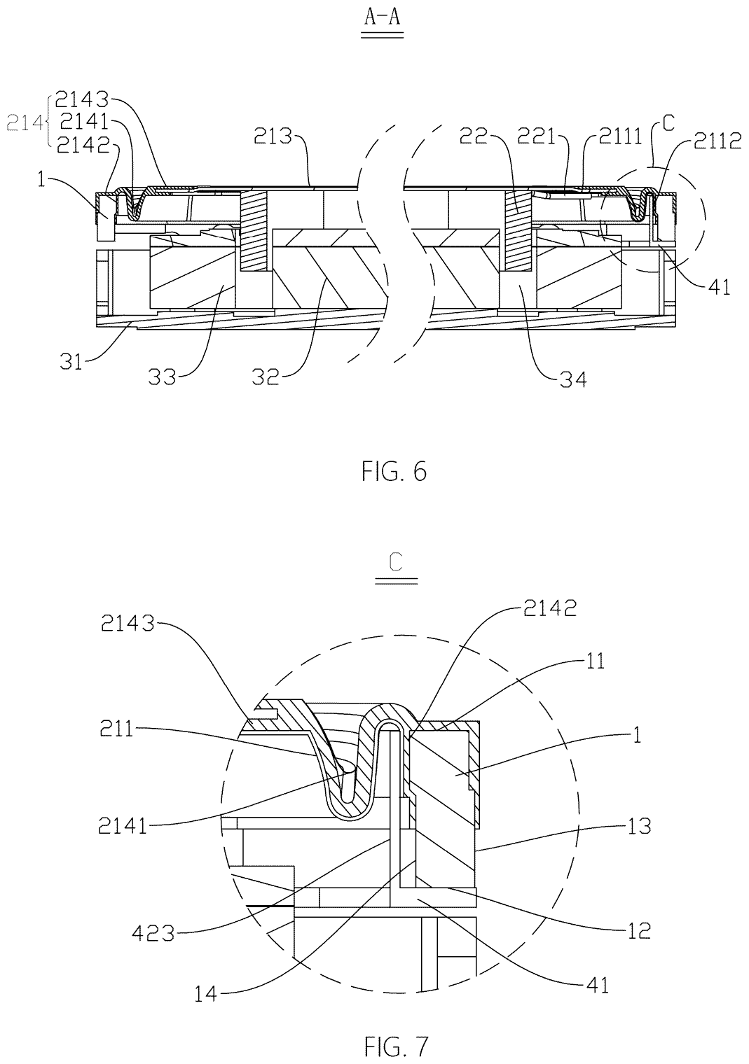

Optionally, referring to the FIGS. 6-8, the connecting portion 42 also can be arranged extending along the inner side wall 14 of the frame 1. The connecting portion 42 of the conductive structure 4 includes an extension part 423 bending and extending from an inner side of the main body portion 41 along the inner side wall 14 in the direction close to the diaphragm 21. The outer fixing portion 2142 of the suspension portion 214 locates on the top surface 11, the inner side wall 14, and the outer side wall 13 of the frame 1. The extension part 423 is electrically connected to the second conductive portion 2112 of the diaphragm 21.

Of course, the connecting portion 42 also can locate in a non-peripheral area of the main body portion 41, and the rest of the components can be adjusted accordingly, which will not be discussed here. The connecting portion 42 is arranged along the outer side wall 13 or the inner side wall 14 of the frame 1, which can minimize the space occupied by the conductive structure 4 in a transverse direction and meet the demand for miniaturization.

Comparing with the related art, through the above structure, by setting the conductive structure 4, the main body portion 41 of the conductive structure 4 fixed to the frame 1 and the connecting portion 42 added to the main body portion 41, the connecting portion 42 electrically connected to the conductive portion 211 to achieve electrical conductivity of the voice coil 22, thereby it can reduce the space occupied by the traditional flexible circuit board due to the flexible circuit board is arranged laterally in related art. Furthermore, the speaker 100 in the present invention can increase the volume of the magnetic circuit system 3 while satisfying miniaturization requirements, improve the driving force, and enhance the acoustic performance of the speaker 100.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker, comprising:
a frame;
a vibration system mounted with the frame, the vibration system comprising:
a diaphragm fixed on the frame, the diaphragm comprising at least one conductive portion;
a voice coil driving the diaphragm to generate sounds, the voice coil electrically connected to the conductive portion;
a magnetic circuit system mounted with the frame; and
at least one conductive structure fixed to the frame and connecting the conductive portion with an external circuit, the conductive structure comprising a main body portion fixedly connected to the frame and a connecting portion bending and extending from the main body portion in a direction close to the diaphragm, the connecting portion electrically connected to the conductive portion of the diaphragm.

2. The speaker as described in claim 1, wherein the conductive portion is arranged on one side of the diaphragm or at least partially embedded in the diaphragm.

3. The speaker as described in claim 1, wherein a number of the conductive portions is two, and two adjacent corner areas of the diaphragm are each provided with one conductive portion, the number of the conductive structures being also two, and each conductive structure arranged corresponding to a position of the conductive portion.

4. The speaker as described in claim 1, wherein the conductive structure is a conductive metal sheet or a flexible circuit board.

5. The speaker as described in claim 1, wherein the conductive structure comprises a substrate and a conductive material dispersed in the substrate, and the conductive material is at least one of graphene, carbon nanotubes, conductive nanofibers, silver powder, and liquid metal.

6. The speaker as described in claim 1, wherein the diaphragm comprises a dome portion and a suspension portion arranged around the dome portion, the voice coil fixed to the dome portion, the suspension portion comprising a bending portion, an outer fixing portion bending and extending from an outer periphery of the bending portion, and an inner fixing portion bending from an inner periphery of the bending portion, the outer fixing portion fixedly connected to the frame, and the inner fixing portion fixedly connected to the dome portion.

7. The speaker as described in claim 6, wherein the conductive portion comprises a first conductive portion arranged on the inner fixing portion or the dome portion, and a second conductive portion arranged on the outer fixing portion, the first conductive portion electrically connected to the voice coil, and the second conductive portion electrically connected to the connecting portion.

8. The speaker as described in claim 7, wherein the first conductive portion is fixedly connected to a leading wire of the voice coil through a conductive adhesive, and the second conductive portion is fixedly connected to the connecting portion through the conductive adhesive, the voice coil, the diaphragm, and the conductive structure achieving circuit conduction with the external circuit.

9. The speaker as described in claim 7, wherein the frame comprises a top surface and a bottom surface arranged opposite to the top surface, an inner side wall and an outer side wall connecting the top surface and the bottom surface, the inner side wall and the outer side wall arranged opposite to each other, the main body portion of the conductive structure fixed to the bottom surface.

10. The speaker as described in claim 9, wherein the outer fixing portion of the suspension portion locates on the top surface and the outer side wall, and the connecting portion of the conductive structure comprises a first portion bending and extending from an outer side of the main body portion along the outer side wall in a direction close to the top surface, and a second portion bending and extending from the first portion in the direction close to the bending portion of the suspension portion, the frame further providing at least one avoidance groove formed by recessing from the top surface to the bottom surface to avoid the second portion, and the second portion accommodated in the avoidance groove.

11. The speaker as described in claim 9, wherein the outer fixing portion of the suspension portion locates on the top surface, the inner side wall, and the outer side wall of the frame, the connecting portion of the conductive structure comprising an extension part bending and extending from an inner side of the main body portion along the inner side wall in the direction close to the diaphragm, the extension part electrically connected to the second conductive portion of the diaphragm.
